(19) United States
(12) Patent Application Publication
(10) Pub. No.: US 2024/0343467 A1
(43) Pub. Date: Oct. 17, 2024

(54) SHIPPING CONTAINER FOR SHIPPING TEMPERATURE-SENSITIVE TRANSPORT MATERIAL

(71) Applicant: REP IP AG, Zug (CH)

(72) Inventors: Nico ROS, Riehen (CH); Stefan RETZKO, Zürich (CH)

(73) Assignee: REP IP AG, Zug (CH)

(21) Appl. No.: 18/293,004

(22) PCT Filed: Jul. 4, 2022
(86) PCT No.: PCT/IB2022/056174

§ 371 Date: Jan. 29, 2024

(30) Foreign Application Priority Data
Jul. 30, 2021 (AT) A 131/2021

(51) Int. Cl. B65D 81/38; B65D 90/06

(52) U.S. Cl. CPC B65D 81/3823; B65D 90/06; B65D 2590/02

(57) ABSTRACT

A shipping container for shipping temperature-sensitive transport material, including container walls which surround and close, on all sides, an interior provided for holding the transport material, the container walls having thermal insulation. Multilayer heat-conducting panels including at least one layer of expanded graphite are arranged in and/or delimit the interior of the shipping container.

### CROSS-REFERENCE TO RELATED APPLICATIONS

The present application is a national phase application of PCT Application No. PCT/IB2022/056174, filed Jul. 4, 2022, entitled “SHIPPING CONTAINER FOR SHIPPING TEMPERATURE-SENSITIVE TRANSPORT MATERIAL”, which claims the benefit of Austrian Patent Application No. 131/2021, filed Jul. 30, 2021, each of which is incorporated by reference in its entirety.

### BACKGROUND OF THE INVENTION

### 1. Field of the Invention

The invention relates to a shipping container for shipping temperature-sensitive goods to be transported, comprising container walls which surround and close off on all sides an interior space provided for receiving the goods to be transported, the container walls having thermal insulation.

### 2. Description of the Related Art

Conventional shipping containers for temperature-controlled shipping of goods comprise an outer shell made of cardboard or plastic, which provides the necessary stability during shipping and offers space for handles and labeling. A thermal insulation layer is arranged inside the outer shell, which is made of polystyrene (EPS) or another insulating material (PUR, PIR, XPS), for example. In the interior space enclosed by the container walls, there is either the transported goods directly together with a coolant (e.g. food cooled with ice) or a layer of coolant (e.g. cold packs with a phase change material), which surrounds an inner shell in which the transported goods are placed.

Conventional shipping containers have the problem that uneven heat input can result in different local temperatures in the transported goods. In areas with high heat input, the transported goods can therefore be heated above the permissible maximum temperature (e.g. 8° C.), which by definition limits the transit time of the entire shipping box, even though significantly lower temperatures prevail in other areas. In this case, the potential of the coolant is not utilized efficiently.

This effect is particularly pronounced if the transported goods completely fill the interior space of the shipping box, preventing internal air circulation which would improve heat distribution. Furthermore, the effect is increased if the coolant is within the transported goods, as a large part of the cooling energy of the internal coolant cannot be used.

A common way to improve internal heat distribution is to make grooves in the inner walls. This ensures that air circulation is maintained, even if the transported goods are resting against the inner walls. One disadvantage of this design, however, is the space required. To achieve proper air circulation, the grooves must have a depth of at least 3-8 mm. This space is either lost to the interior space or the wall structure. In addition, differences in air density in a passively cooled container usually result in a temperature gradient in the interior space. Warm air rises upwards and heats the transported goods locally. This reduces the positive effect of air circulation on heat distribution.

Another possible way to improve internal heat distribution is to use an inner shell made of aluminum or an inner shell comprising aluminum elements. However, this leads to a significant increase in weight and has a negative effect on the production costs and recyclability of the shipping box.

### SUMMARY OF THE INVENTION

The present invention therefore aims to improve heat distribution within shipping containers. This applies not only to the heat distribution along the inner shell of the shipping container, but also within the transported goods.

The improved heat distribution should lead to an equalization of the temperature of the transported goods and any coolant in the entire shipping container and thus to a longer service life.

The available space inside the shipping container should be utilized as much as possible. The thickness of the wall structure should be minimized and the interior space should be allowed to be fully loaded. The heat should be distributed without air circulation.

After all, the shipping container should be inexpensive and easy to manufacture, light in weight and recyclable. Handling should be as simple and flexible as possible.

To solve this problem, the invention essentially provides in a shipping container of the type mentioned at the beginning that heat conducting plates are arranged in the interior space and/or delimiting the interior space, which are constructed in several layers and have at least one layer of expanded graphite.

The multilayer heat conducting plates according to the invention are very easy and flexible to use. On the one hand, the interior space can be lined with the heat conducting plates to create a highly thermally conductive inner shell within the thermal insulation. On the other hand, the heat conducting plates can be inserted as intermediate layers within the transported goods.

Expanded graphite is characterized by its low weight. Expanded graphite has a high thermal conductivity and is therefore ideal for compensating for uneven heat input, for example due to thermal bridges in the thermal insulation of the container. This has a positive effect on the maximum transit time of the shipping container.

Expanded graphite (also known as exfoliated graphite) is produced by inserting foreign components (intercalates) between the lattice layers of graphite. Such expandable graphite intercalation compounds are usually produced by dispersing graphite particles in a solution containing an oxidizing agent and the intercalation compound. Commonly used oxidizing agents are nitric acid, potassium chlorate, chromic acid, potassium permanganate and the like. Concentrated sulphuric acid, for example, is used as the intercalation compound. When heated to a temperature above the so-called onset temperature, the expandable graphite intercalation compounds are subject to a strong increase in volume with expansion factors of more than 200, which is caused by the fact that the intercalation compounds embedded in the layer structure of the graphite are decomposed by the rapid heating to this temperature with the formation of gaseous substances, whereby the graphite layers are driven apart like accordions, i.e. the graphite particles are expanded or inflated perpendicular to the layer plane.

If the fully expanded graphite is compacted under the directional effect of pressure, the layer planes of the graphite preferably arrange themselves perpendicular to the direction in which the pressure acts, whereby the individual aggregates interlock with one another. This allows a self-supporting layer of expanded graphite to be produced without the addition of a binder.

In a preferred design, the heat conducting plate used according to the invention is therefore characterized by the fact that the layer planes of the expanded graphite run essentially parallel to each other and parallel to the plate plane. This results in an advantageous anisotropic thermal conductivity of the heat conducting plate. This means that the thermal conductivity of the expanded graphite is high along its outer surface, but low when passing through the material. This dual functionality leads on the one hand to the desired heat distribution in the plate plane and on the other hand to a reduction of the heat input into the transported goods transverse to the plate plane.

In particular, the layer of expanded graphite in the plate plane preferably has a thermal conductivity of 190-760 W/mK or 190-380 W/mK.

In order to support the possibly unstable layer of expanded graphite and to improve its manageability, it is preferably provided that the heat conducting plates have at least one carrier layer on which the layer of expanded graphite is arranged and to which it is possibly connected or bonded.

In particular, the layer of expanded graphite can be arranged between two carrier layers. The at least one carrier layer can advantageously consist of cardboard or plastic.

Preferably, the at least one carrier layer has a thickness of 0.3-1 mm. The at least one layer of expanded graphite preferably has a thickness of 0.4-4 mm, preferably 0.4-1 mm.

Due to the presence of the carrier layer(s), the heat conducting plate has a reduced average thermal conductivity in the plate plane compared to the pure expanded graphite, which can advantageously be in the range of 60-180 W/mK.

The heat conducting plates can be arranged in such a way that the heat conducting plates surround the interior space of the shipping container on all sides and without gaps. The heat conducting plates thus form an inner shell, for example, in which the transported goods are located. In the case of a rectangular shipping container, a heat conducting plate is preferably assigned to each of the six walls, so that the inner shell is made up of six heat conducting plates. The heat conducting plates, in particular their edge areas, preferably touch each other directly, so that heat is equalized around the entire interior space, whereby heat can be conducted via the inner shell, for example from one side of the interior space to an opposite side.

The heat conducting plates can be firmly connected to the container walls. Alternatively, the heat conducting plates can simply be placed against the container walls, whereby adjacent heat conducting plates can be structurally connected to each other (e.g. with a toothing) in order to prevent them from tipping into the interior space. Finally, the cover plate is inserted, which is associated with a removable container wall, i.e. a lid. The cover plate can be alternatively attached to the lid, e.g. by gluing.

As an alternative to the arrangement of the heat conducting plates on the container walls or in addition to this, heat conducting plates can be provided which traverse the interior space of the shipping container. The heat conducting plates can form space dividers between which the transported goods are arranged. In a preferred embodiment, the heat conducting plates are arranged in a grid or lattice shape and divide the interior space into a plurality of cuboid receiving chambers, in each of which at least one temperature-sensitive product can be arranged, such as a box of medication or the like.

The influence of the heat conducting plates on the running time of the shipping container is particularly high if the shipping container has a coolant or a coolant element to which at least one of the heat conducting plates is arranged adjacent, in particular in contact with it. A coolant element is an element, such as a container, in which a liquid or liquefiable coolant is contained. In particular, a phase change material can be used as a coolant. Cooling elements are designed as cooling packs, for example.

The coolant is preferably distributed within the transported goods. This can be the case, for example, with medicine boxes with cold packs inside. To make optimum use of the coolant, the heat conducting plates must be inserted both around the medicine boxes and as intermediate layers. In this case, the service life of the shipping container will be more than doubled by using the present invention. This corresponds to an increase of >100%.

Another example where the influence of heat conducting plates is very high is an incomplete cover with coolant elements. A common problem with the use of cold packs is that, for design reasons, it is not possible to achieve a sealed enclosure for the transported goods. This leads to a local heat drop and a premature end to the running time. With the use of heat conducting plates according to the invention, the heat is evenly distributed and absorbed by the cold packs. This leads to a significant increase in running time.

A further preferred option for combining the heat conducting plates with cooling elements can be achieved by providing an outer layer of heat conducting plates which surround the interior space on all sides, and an inner layer of heat conducting plates which surround the interior space on all sides, with passive cooling elements arranged between the outer and inner layers.

The coolant can also be provided as part of the container wall. A preferred design in this context is that the container walls are multi-layered and have at least one layer of a coolant, such as a phase change material, as thermal insulation.

The thermal insulation arranged in the container walls can alternatively or additionally also be designed as a conventional insulating layer, whereby the container walls are designed in multiple layers and have at least one thermal insulation layer as thermal insulation. The thermal insulation layer can be made of polystyrene (EPS) or another insulating material such as polyurethane (PUR), polyisocyanurate (PIR) or extruded polystyrene (XPS). The thermal insulation layer preferably has a thermal conductivity of <0.05 W/mK measured in a direction from the outside to the inside.

The shipping container according to the invention is preferably box-shaped. A box-shaped shipping container preferably has a rectangular base body that is open on one side and a lid, whereby the lid is formed in one piece with the base body, e.g. connected by a bent edge, or is formed as a separate lid that can be slid onto the base body.

Preferably, the container walls of the box-shaped shipping container are multi-layered and have an outer shell made of cardboard or plastic. Another layer of the box-shaped shipping container, arranged inside the outer shell, can be formed by a thermal insulation layer. The thermal insulation layer does not have to be materially connected to the outer shell made of cardboard or plastic, but the thermal insulation layer can merely be inserted into the outer shell. The thermal insulation layers of the container walls can themselves form a self-supporting cuboid body that is inserted into the cardboard or plastic outer shell.

The shipping container according to the invention is designed in particular for mail or parcel shipping and is therefore to be distinguished from a freight container or the like. The shipping container according to the invention therefore preferably has maximum dimensions of 80×50×50 cm, preferably 60×50×50 cm.

### BRIEF DESCRIPTION OF THE DRAWINGS

The invention is explained in more detail below with reference to embodiments shown schematically in the drawing. Therein,

FIG. 1 shows a detailed view of a heat conducting plate,

FIG. 2 shows a cross-section through a first embodiment of a shipping container according to the invention with outer heat conducting plates,

FIG. 3 shows a cross-section through a second embodiment of a shipping container according to the invention with outer heat conducting plates and intermediate layers, and

FIG. 4 shows a cross-section through a third embodiment of a shipping container according to the invention with outer and inner heat conducting plates.

### DETAILED DESCRIPTION

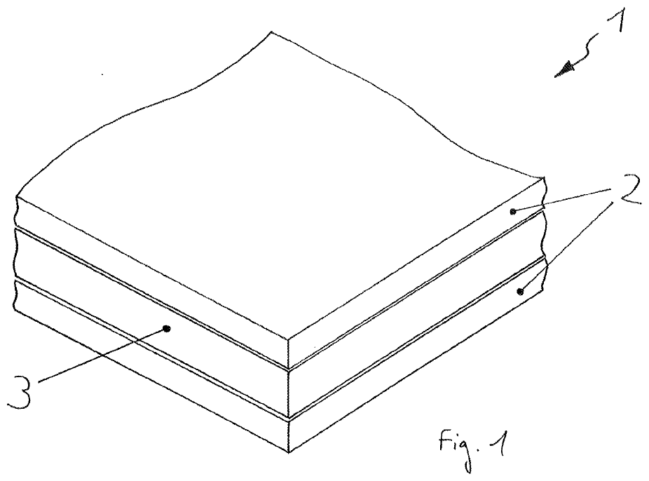

FIG. 1 schematically shows a heat conducting plate 1 according to the invention. The heat conducting plate 1 is designed as a composite plate consisting of several layers. The heat conducting plate 1 consists of two outer layers 2 made of cardboard or plastic and a layer 3 made of expanded graphite. The outer layers 2 stabilize the graphite core and have a thickness of 0.3-1 mm each. The inner graphite layer 3 has a thickness of 0.4-1 mm, resulting in a total composite thickness of 1-3 mm.

The individual layers or plates are joined by adhesive or a surrounding film (not shown). The heat conducting plate 1 can be manufactured in different sizes (length and width in the range 20-1000 mm), which are adapted to the shipping container. Alternatively, the heat conducting plates 1 can be cut to the size of the shipping container.

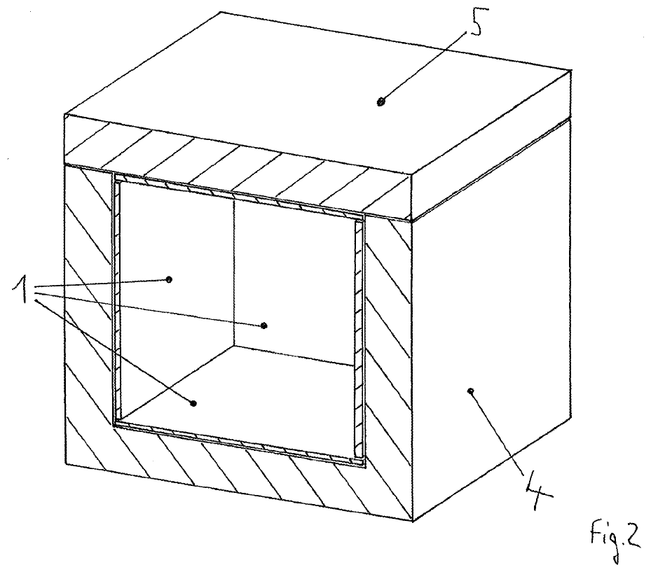

FIG. 2 shows a first embodiment of a shipping container according to the invention, which is designed as a cuboid shipping box. The shipping box comprises six box walls, which are formed by a lower shell or base 4 and a lid 5, each of which consists of an insulating material (e.g. polystyrene) or a multi-layered wall structure. The interior space within the box walls is lined with heat conducting plates 1, which are designed as shown in FIG. 1. To this end, the lower plate 1 is first inserted. The plates 1 on the side walls are structurally connected to each other (e.g. with a toothing) to prevent them from tipping into the interior space. The cover plate 1 is inserted last. The cover plate 1 can be alternatively attached to the lid 5, e.g. by bonding.

This is the simplest embodiment of the invention. Penetrating heat is distributed evenly over the outer inner shell made of graphite composite plates. Thermal bridges in the insulation layer are evened out.

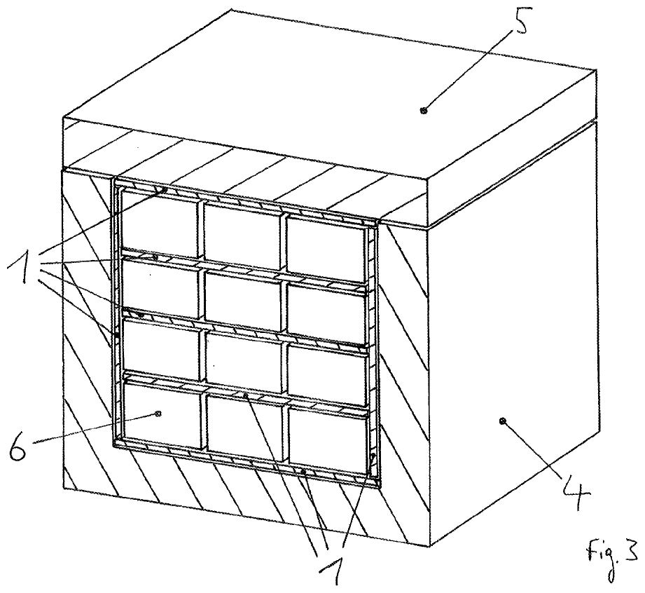

FIG. 3 shows a second embodiment of a shipping container according to the invention, which is designed as a cuboid shipping box. The shipping box again consists of a lower shell 4 and a lid 5, each of which is made of an insulating material (e.g. polystyrene) or a multi-layered wall structure. The interior space within the insulation layer is lined with heat conducting plates 1, which are designed as shown in FIG. 1. The transported goods consist of boxes 6, each of which is equipped with a coolant. For example, boxes with integrated phase change material can be used, as described in WO 2020/261104 A1 or WO 2020/261108 A1.

Heat conducting plates 1 are inserted as intermediate layers between the individual layers of the transported goods. The cover plate 1 is inserted last. The cover plate can be alternatively attached to the lid 5, e.g. by gluing.

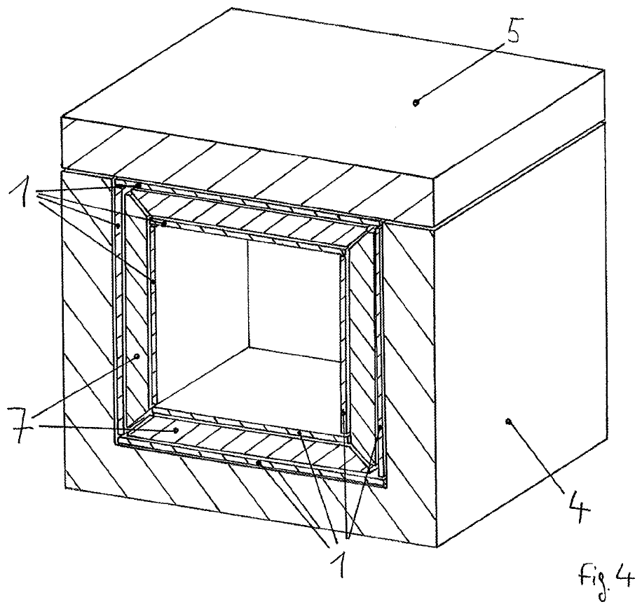

FIG. 4 shows a third embodiment of a shipping container according to the invention, which is designed as a cuboid shipping box. The shipping box consists of a bottom shell 4 and a lid 5, each of which is made of an insulating material (e.g. polystyrene) or a multi-layered wall structure. The interior space of the insulation layer is lined with heat conducting plates 1, which are designed as shown in FIG. 1. A layer of coolant 7 is inserted inside the outer heat conducting plates 1, which consists of cooling packs, for example. This is followed by an inner layer of heat conducting plates 1.

Although only four sides of the container are shown in the cross-sectional views in FIGS. 2, 3 and 4, it is clear that the other two sides have the same structure.

1-20. (canceled)

21. A shipping container for shipping temperature-sensitive goods to be transported, comprising:
container walls surrounding and closing off on all sides an interior space provided for receiving the goods to be transported, the container walls having thermal insulation; and
heat conducting plates arranged at least one of in the interior space and delimiting the interior space, the heat conducting plates having a multilayer structure and having at least one layer of expanded graphite;
wherein the heat conducting plates surround the interior space on all sides and without gaps, the heat conducting plates having at least one carrier layer on which the layer of expanded graphite is arranged and the at least one carrier layer consisting of one of cardboard and plastic.

22. A shipping container according to claim 21, wherein:
the at least one carrier layer comprises at least two carrier layers; and
the layer of expanded graphite is arranged between two of the at least two carrier layers.

23. A shipping container according to claim 21, wherein the at least one carrier layer has a thickness of 0.3-1 mm.

24. A shipping container according to claim 21, wherein the at least one layer of expanded graphite has a thickness of 0.4-4 mm.

25. A shipping container according to claim 21, wherein the layer of expanded graphite has a thermal conductivity of 190-760 W/mK in a plate plane.

26. A shipping container according to claim 21, wherein the heat conducting plates have a thermal conductivity of 60-180 W/mK in a plate plane.

27. A shipping container according to claim 21, wherein the heat conducting plates traverse the interior space.

28. A shipping container according to claim 21, wherein the heat conducting plates form space dividers between which the transported goods are arranged.

29. A shipping container according to claim 21, wherein the heat conducting plates surround passive cooling elements arranged in the interior space of the shipping container.

30. A shipping container according to claim 21, wherein:
an outer layer of heat conducting plates is provided, which surround the interior space on all sides;
an inner layer of heat conducting plates is provided, which surround the interior space on all sides; and
passive cooling elements are arranged between the outer and the inner layer.

31. A shipping container according to claim 21, wherein the container walls are multilayered and have at least one layer of a coolant as thermal insulation.

32. A shipping container according to claim 21, wherein the container walls are multi-layered and have at least one thermal insulation layer as thermal insulation.

33. A shipping container according to claim 21, wherein the container walls are multi-layered and have an outer shell made of one of a cardboard and a plastic.

34. A heat conducting plate for use in a shipping container for shipping temperature-sensitive goods, comprising
at least one layer of expanded graphite; and
two carrier layers between which the at least one layer of expanded graphite is arranged;
wherein the two carrier layers are made of one of cardboard and plastic;
wherein container walls surround and close off on all sides an interior space provided for receiving the goods to be transported, the container walls having thermal insulation;
wherein the heat conducting plates are arranged at least one of in the interior space and delimiting the interior space; and
wherein the heat conducting plates surround the interior space on all sides and without gaps.

35. The heat conducting plate according to claim 34, wherein the carrier layers have a thickness of 0.3-1 mm.

36. The heat conducting plate according to claim 34, wherein the at least one layer of expanded graphite has a thickness of 0.4-4 mm.
